(19) United States
(12) Patent Application Publication
(10) Pub. No.: US 2026/0113705 A1
(43) Pub. Date: Apr. 23, 2026

(54) METHODS FOR MAKING USER EQUIPMENT AWARE OF DISCONTINUOUS TRANSMISSION OR RECEPTION BY A NETWORK

(71) Applicant: Telefonaktiebolaget LM Ericsson (publ), Stockholm (SE)

(72) Inventors: Sladana JOSILO, SOLNA (SE); Lian ARAUJO, SOLNA (SE); Sina MALEKI, MALMÖ (SE); Ali NADER, MALMÖ (SE); Andres REIAL, HÖLLVIKEN (SE); Ajit NIMBALKER, DUBLIN, CA (US); Nianshan SHI, JÄRFÄLLA (SE)

(73) Assignee: Telefonaktiebolaget LM Ericsson (publ), Stockholm (SE)

(21) Appl. No.: 19/116,255

(22) PCT Filed: Sep. 12, 2023
(86) PCT No.: PCT/SE2023/050893

§ 371 Date: Mar. 27, 2025

Related U.S. Application Data
(60) Provisional application No. 63/410,845, filed on Sep. 28, 2022.

(51) Int. Cl. H04W 52/02

(52) U.S. Cl. CPC H04W 52/0216; H04W 52/0235

(57) ABSTRACT

A method performed by a user equipment (UE) includes receiving, from a wireless communication network, a configuration for sleeping occasions for a network node, wherein the configuration indicates an off-occasion during which transmission or reception activity by the network node is reduced or suspended, and communicating with the network node in accordance with the configuration. A method performed by a network node includes transmitting, to a UE, a configuration for sleeping occasions for the network node, wherein the configuration indicates an off-occasion during which transmission or reception activity by the network node is reduced or suspended, and communicating with the UE in accordance with the configuration.

### TECHNICAL FIELD

The present disclosure relates to wireless communication systems, and in particular to wireless communication systems that employ discontinuous transmission or reception.

### BACKGROUND

Energy consumption is a considerable challenge for New Radio (NR) 5G systems. A major contributor to the energy consumption is the radio unit of a radio access network (RAN) system. The network (NW) power consumption for NR is said to be less compared to that of Long Term Evolution (LTE) systems because of its lean design. For example, no cell-specific reference signals (CRS) are used and the synchronization signal block (SSB) periodicity is by default 20 ms. However, in the current implementation, a NR system might consume more energy compared to LTE, partly due to higher bandwidths (BW), shorter transmission time intervals (TTI) and massive number of antennas. This is still evident even at times when cells and beams are lightly loaded or serve no traffic or no users at all. One basic method for saving NW energy is to simply turn off a base station (such as a gNodeB, or gNB) or cell completely when it is seen or predicted that there is little or no traffic or even no user in the cell.

### Discontinuous Reception

As in LTE, NR includes mechanisms for discontinuous reception (DRX) for the user equipments (UE) in order to reduce UE power consumption. A DRX cycle for a UE is illustrated in FIG. 1. As shown therein, a DRX cycle includes a period in which the UE is assumed to be active and able to receive communications from the network (ON Duration) followed by a period in which the UE is assumed to be sleeping. The DRX cycle repeats while the UE is configured with DRX.

DRX may be used both in radio resource control (RRC) connected mode (C-DRX) and RRC Idle/Inactive (DRX) and serves as a common agreement between the UE and the NW that upon any downlink (DL) traffic, the NW will only try to contact the UE during the on-time of the DRX pattern. Based on a configured DRX cycle, the UE then only needs to monitor the DL channels according to the agreement and sleep otherwise. When it comes to uplink (UL) traffic, the UE may initiate connection regardless of the DRX configuration, i.e., the gNB has to be prepared to receive UL communications at any time.

### SUMMARY

A method performed by a user equipment include receiving, from a wireless communication network, a configuration for sleeping occasions for a network node, wherein the configuration indicates an off-occasion during which transmission or reception activity by the network node is reduced or suspended, and communicating with the network node in accordance with the configuration.

In some embodiments, communicating with the network node in accordance with the configuration includes refraining from communicating with the network node while the network node is in an off-occasion according to the configuration.

In some embodiments, communicating with the network node in accordance with the configuration includes communicating with the network node at a reduced frequency while the network node is in an off-occasion according to the configuration.

The off-occasion may apply to downlink transmissions from the network node to the UE and/or to uplink transmissions from the UE to the network node.

The configuration may include a periodic configuration that indicates a length of off-occasions and a periodicity of off-occasions for the network node.

The configuration may indicate a time when a first off-occasion of the configured off-occasions should occur.

In some embodiments, the configuration includes an off-occasion timer during which transmission or reception activity by the network node is reduced or suspended and/or an on-occasion timer during which transmission or reception activity by the network node is normal.

The configuration may indicate a time when the off-occasion will begin and/or a duration of the off-occasion.

In some embodiments, the configuration is provided in dedicated signaling, via RRC signaling or a MAC control element, in common signaling, or in system information.

The method may further include receiving, from the network node, an updated configuration for sleeping occasions for the network node, and communicating with the network node in accordance with the updated configuration. The updated configuration may be provided via dedicated signaling or via common signaling.

The configuration may include multiple sleeping configurations for off-occasions for the network node.

In some embodiments, the configuration includes a first sleeping configuration that applies to a first type of radio bearer and a second configuration that applies to a second type of radio bearer.

In some embodiments, the configuration includes a first sleeping configuration that applies to a first type of service and a second configuration that applies to a second type of service.

In some embodiments, the configuration includes a first sleeping configuration that applies to a first type of uplink channel and a second configuration that applies to a second type of uplink channel.

The method may further include sending a wake-up signal, WUS, to the network node during the off-occasion.

The method may further include transmitting a preferred configuration for off-occasions to the network node.

The configuration may be received from the network node. In some embodiments, the network node is a first network node, and the configuration is received from a second network node.

In some embodiments, the UE enters a sleep mode or another reduced power mode during the off-occasion.

The method may further include providing user data, and forwarding the user data to a host via the transmission to the network node.

The configuration may indicate a time when an on-occasion during which transmission or reception activity by the network node is not reduced or suspended will begin and/or a duration of the on-occasion.

A user equipment according to some embodiments includes a processing circuitry, a communication interface coupled to the processing circuitry, and a memory coupled to the processing circuitry. The memory includes computer readable program instructions that, when executed by the processing circuitry, cause the user equipment to perform operations including receiving, from a wireless communication network, a configuration for sleeping occasions for a network node, wherein the configuration indicates an off-occasion during which transmission or reception activity by the network node is reduced or suspended, and communicating with the network node in accordance with the configuration.

A computer program product comprising a non-transitory storage medium containing computer readable program instructions that, when executed by processing circuitry of a user equipment, cause the user equipment to perform operations as described above.

A method performed by a network node includes transmitting, to a user equipment, a configuration for sleeping occasions for the network node, wherein the configuration indicates an off-occasion during which transmission or reception activity by the network node is reduced or suspended, and communicating with the UE in accordance with the configuration.

The configuration may be based on transmission or reception activity of UEs served by the network node. In some embodiments, the configuration is based on a preferred configuration indicated by a UE served by the network node.

The network node may be a first network node, and the method may further include transmitting, to the UE, a configuration for sleeping occasions for a second network node, wherein the configuration indicates an off-occasion during which transmission or reception activity by the second network node is reduced or suspended.

The network node may include a central unit, CU, and a distributed unit, DU, and the method may further include determining the configuration at the CU, and communicating the configuration from the CU to the DU. In some embodiments, the method may further include determining the configuration at the DU, and communicating the configuration from the DU to the CU.

In some embodiments, the method may further include determining a proposed configuration for discontinuous transmission or reception, DTRX, at the DU, and communicating the proposed configuration for DTRX from the DU to the CU, wherein the CU generates the configuration based on the proposed DTRX configuration.

The may further include obtaining user data, and forwarding the user data to a host or a user equipment.

The may further include determining the configuration for sleeping occasions for the network node.

The off-occasion may apply to downlink transmissions from the network node to the UE, or to uplink transmissions from the UE to the network node.

The configuration may include a periodic configuration that indicates a length of off-occasions and a periodicity of off-occasions for the network node.

The configuration may indicate a time when a first off-occasion of the configured off-occasions should occur.

The configuration may include an off-occasion timer during which transmission or reception activity by the network node is reduced or suspended and/or an on-occasion timer during which transmission or reception activity by the network node is normal.

The configuration may indicate a time when the off-occasion will begin and/or a duration of the off-occasion.

The configuration may be transmitted to the UE in dedicated signaling, via RRC signaling or a MAC control element, in common signaling or in system information.

The method may further include transmitting, to the UE, an updated configuration for sleeping occasions for the network node, and communicating with the UE in accordance with the updated configuration.

The configuration may be transmitted to the UE via dedicated signaling or via common signaling.

The configuration may include multiple sleeping configurations for off-occasions for the network node.

In some embodiments, the configuration may include a first sleeping configuration that applies to a first type of radio bearer and a second configuration that applies to a second type of radio bearer.

In some embodiments, the configuration includes a first sleeping configuration that applies to a first type of service and a second configuration that applies to a second type of service.

In some embodiments, the configuration includes a first sleeping configuration that applies to a first type of uplink channel and a second configuration that applies to a second type of uplink channel.

The method may further include receiving a wake-up signal, WUS, from the UE during the off-occasion.

The method may further include receiving a preferred configuration for off-occasions from the UE.

A network node according to some embodiments includes a processing circuitry, a communication interface coupled to the processing circuitry, and a memory coupled to the processing circuitry. The memory includes computer readable program instructions that, when executed by the processing circuitry, cause the network node to perform operations including transmitting, to a user equipment, UE, a configuration for sleeping occasions for the network node, wherein the configuration indicates an off-occasion during which transmission or reception activity by the network node is reduced or suspended, and communicating with the UE in accordance with the configuration.

A computer program product comprising a non-transitory storage medium containing computer readable program instructions that, when executed by processing circuitry of a network node, cause the network node to perform operations described above.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a DRX cycle for a UE.

FIG. 2 illustrates operations of a UE and network node according to some embodiments.

FIG. 3 shows an example of a communication system in accordance with some embodiments.

FIG. 4 shows a UE in accordance with some embodiments.

FIG. 5 shows a network node in accordance with some embodiments.

FIG. 6 is a block diagram of a host.

FIG. 7 is a block diagram illustrating a virtualization environment in which functions implemented by some embodiments may be virtualized.

FIG. 8 shows a communication diagram of a host communicating via a network node with a UE over a partially wireless connection in accordance with some embodiments.

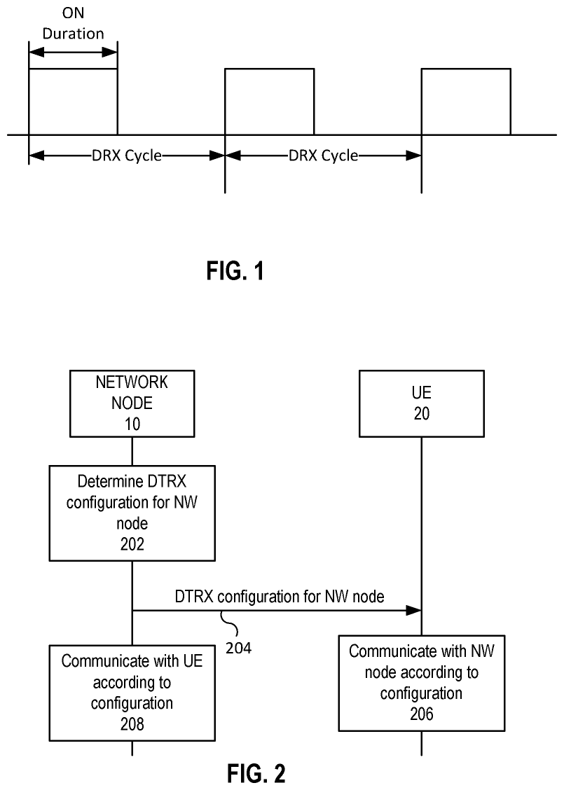

### DETAILED DESCRIPTION

As noted above, DRX may be used to reduce energy consumption in a wireless communication system. However, there currently exist certain challenges. As a gNB is not aware of potential UL traffic demands of the UEs, the gNB cannot freely employ sleeping patterns. If the gNB were to go to sleep, it would lead to several problems. For example, a UE may send a scheduling request to the NW, or measure the cell quality. However, if the NW is in a sleep mode, it may not be listening to the UE request or may not be transmitting the reference signals for the UE to measure, potentially leading to outage issues, such as radio link failure in connected mode, or an out of coverage indication in Idle/Inactive mode.

Additionally, in the current specifications, while there is an efficient C-DRX or DRX mechanism for the UE, there is not such a mechanism on the NW side, leading to unnecessary transmissions, as well as listening even when the UE may be in a DRX off duration.

Certain aspects of the disclosure and their embodiments may provide solutions to these or other challenges. In particular, some embodiments provide systems and/or methods that may enable a UE to receive information about NW sleeping patterns, and to act upon them accordingly.

Certain embodiments may provide one or more of the following technical advantages. According to some embodiments, a UE will be informed about the NW sleeping patterns and may trigger procedures based on this pattern. The UE awareness of NW sleeping patterns will help in avoiding the events such as a false detection of a radio link failure (while the NW is sleeping) or re-attempts to send a UL message during the NW sleeping period.

Some of the embodiments contemplated herein will now be described more fully with reference to the accompanying drawings. Embodiments are provided by way of example to convey the scope of the subject matter to those skilled in the art.

Sleeping occasion(s) are occasions in which transmissions and/or reception are reduced or not expected at all (due to network sleeping pattern for energy saving) and hence they can be applicable to multiple NW sleep states (e.g., light sleep, or a cell that is completely off).

An occasion (e.g., symbols/slots/frames/etc.) may be indicated as off occasion or an on occasion based on signaling or other indication (e.g., Off/On signaling) from a gNB. Some occasions (which may be pre-determined or dynamically configured) may be considered on occasions. For example, such occasions could correspond to symbols in which SSB is transmitted. During an off-occasion, gNB transmission or reception of signals/channels is not expected. A UE can expect that a gNB can transmit/receive signals/channels during an on-occasion. In certain embodiments, during an off-occasion, gNB transmission or reception of signals/channels is expected with relatively reduced settings (e.g., sparse in time/frequency) relative to an on-occasion. In some cases, the UE is not allowed to transmit (and/or receive) during an off-occasion. In some cases, off-occasion may be defined for both downlink and uplink, downlink only, or uplink only. The off-occasions can be indicated using signalling, such as downlink control information (DCI) signalling, medium access control (MAC)-control element (CE) signalling, or RRC signaling.

### UE Aspects

According to some embodiments, a UE can be configured with NW sleeping occasions (or off-occasions). Referring to FIG. 2, a network node 10 determines a discontinuous transmission or reception (DTRX) configuration including an off-occasion for the network node (block 202). The network node transmits the DTRX configuration to a UE (arrow 204). The UE then applies the DTRX configuration for the network node and communicates with the network node according to the DTRX configuration (block 206). The network node also applies the DTRX configuration and communicates with the UE according to the DTRX configuration (block 208).

Depending on the occurrence of the NW sleeping occasions, the UE configuration can be provided for periodic, one-shot or semi-persistent NW sleeping occasions. The UE can be provided with multiple configurations such that the NW can easily trigger or indicate/use a specific configuration as needed.

In the case of a periodic configuration, a specific length for off-occasions may be provided to the UE together with a periodicity of when such off-occasions would happen. The configuration could also include an offset value to indicate when the first off-occasion should occur. A similar approach could be adopted to indicate on-occasions. During the NW off-occasions, the UE can go to sleep mode itself. During the NW on-occasions, the UE can continue being in sleep mode or it can go to a non-sleep mode (e.g., perform transmissions and receptions) during the whole or only the part of the NW-on-occasion duration.

Alternatively, a periodic configuration could also be defined based on an on-occasion timer and off-occasion timer, such that, once configured by the network, the UE starts the on-occasion timer, which should span the duration of the NW on-occasions. Upon expiry of the on-occasion timer, the UE starts the off-occasion timer, which should span the duration of the NW off-occasion. Upon expiry of the off-occasion timer, the UE starts the on-occasion timer, and so on. During the duration of off-occasion timer, the UE can go to sleep mode itself. During the duration of on-occasion timer, the UE can continue being in sleep mode or it can go to a non-sleep mode (e.g., perform transmissions and receptions) during the whole or only the part of on-occasion timer duration.

In the case of a one-shot configuration, a specific length for an off-occasion may be provided to the UE together with an offset value to indicate when this off-occasion should occur. A similar approach could be adopted to indicate on-occasion. This is a one-shot configuration not maintained by the UE since it indicates only a single off or on occasion. During a single off-occasion, the UE can go to sleep mode itself. During a single on-occasion, the UE can continue being in sleep mode or it can go to a non-sleep mode (e.g., perform transmissions and receptions) during the whole or only the part of the on-occasion.

In the case of a semi-periodic configuration, a specific length for off-occasions may be provided to the UE together with a periodicity of when such off-occasions would happen. The configuration could also include an offset value to indicate when the first off-occasion should occur. A similar approach could be adopted to indicate on-occasions. This may further indicate when to start/stop such periodic configuration. During the NW off-occasions, the UE can go to sleep mode itself. During the NW on-occasions, the UE can continue being in sleep mode or it can go to a non-sleep mode (e.g., perform transmissions and receptions) during the whole or only the part of the NW-on-occasion duration.

The UE can be configured with NW sleeping occasions and conditions in various ways.

For example, in some embodiments, a UE may be configured with sleeping occasions via dedicated signaling. Accordingly, in some embodiments, the current NW sleep configuration may be provided in a dedicated RRC message (such as an RRCReconfiguration message). In one aspect, the configuration may become active immediately upon provisioning. In another aspect the configuration may be latent, and may remain inactive until later activated. In yet another aspect, whether the configuration is immediately activated or latent may be controlled through a configuration parameter.

In some embodiments, a NW sleep configuration may be provided in a MAC CE command.

In some embodiments, multiple configurations may be provided in a dedicated RRC message, and the current configuration is signaled/(de-)activated dynamically via DCI, where the DCI contains an index to select one of the NW sleep occasion pattern configurations. A dedicated or group-common DCI may be used for indicating the current configuration.

In some embodiments, multiple configurations may be provided in a dedicated RRC message, and the current configuration is signaled/(de-)activated dynamically via downlink (DL) MAC CE signaling that contains an index to one of the NW sleep occasion pattern configurations.

In other embodiments, a UE may be configured with sleeping occasions and conditions via system information, e.g., in SIB1 or another system information block (SIB) or in a dedicated energy saving SIB.

In the case of any subsequent change to the sleeping occasions, there are various options for updating the UE.

For example, in some embodiments, any subsequent change to the occasions requires another dedicated signaling (e.g., a dedicated RRC message).

In further embodiments, any subsequent change to the occasions requires another reception of system information (SI). A change may be indicated via a SI update short message. Alternatively, a change may not be indicated via a SI update message but the UEs may be expected to poll the NW sleeping occasion pattern in the SI. UE may be configured with a guaranteed validity timer for the currently configured NW sleeping occasion pattern to reduce the SI poll rate.

In some embodiments, a subsequent change may be indicated in the initial NW sleeping occasion configuration. For example, the RRC or SI-based configuration may include a timer or a reference time setting indicating a time instant when the sleeping occasion configuration ends and the gNB will return to regular (sleepless) operation mode.

Configured occasions and subsequent changes to the occasions can be done using a combination of dedicated signaling (e.g., a dedicated RRC message) and system information.

In one example, an initial configuration may be provided via dedicated signaling (e.g., a dedicated RRC message) and subsequent changes may be indicated via system information.

In another case, the initial configuration may be provided via system information and subsequent changes may be indicated via dedicated signaling (e.g., a dedicated RRC message).

In another case, the initial configuration and some of the subsequent changes may be provided via dedicated signaling (e.g., a dedicated RRC message) and the other subsequent changes may be provided via system information.

In yet another case, the initial configuration and some of the subsequent changes may be provided via system information and the other subsequent changes may be provided via dedicated signaling (e.g., a dedicated RRC message).

A UE can be configured with multiple conditions/criteria and associated occasion/patterns for a network DRX configuration. Each occasion/pattern may only be applicable to one or more specific conditions. For example, the UE can be provided with a first pattern including more occasions for UL access for certain higher priority actions compared to a second or more patterns including fewer than the first pattern for lower priority actions.

In some embodiments, a UE may be configured with a first pattern applicable to access related to a first type of radio bearer (e.g., signalling radio bearer, SRB, or SRB with a specific number such as SRB1) and a second pattern applicable to a second type of radio bearer (e.g., data radio bearers, DRB, or another SRB).

In some embodiments, UE may be configured with a first pattern applicable to access related to a first type of service (e.g., identified with a first 5G quality of service (QoS) indicator (5QI) and a second pattern applicable to a second type of service (e.g., a second 5QI).

In some embodiments, a UE may be configured with a first pattern applicable to access related to a first type of UL channel (e.g., the physical uplink control channel, or PUCCH) or a first type of UL channel used specifically for certain action (e.g., scheduling request, or hybrid automatic repeat request, HARQ, feedback), and a second pattern applicable to access related to a second type of UL channel (e.g., physical uplink shared channel, or PUSCH) or a second type of UL channels used specifically for certain action (e.g., MAC-CE report of certain kind such as buffer status report, and/or radio link control, RLC, STATUS report).

In some embodiments, when a UE is configured with NW sleeping occasions as described above, the signaling for UE DRX configuration may be re-used, with addition of a new field to indicate that no transmission nor reception should occur upon off durations (or DRX off or outside DRX active time) of the configured DRX cycles. The UE can be configured with additional exceptions, e.g., measurement related signaling still going on such as SSB or CSI-RS transmissions.

In some embodiments, the UE can be configured with a wake-up signal (WUS) or similar mechanism, such that the UE can transmit a WUS during the NW sleeping times in order to wake up the NW immediately or indicate to the NW that it should monitor UE UL in the next NW side DTRX ON duration, or that it should transmit the reference signals (RS) or other requested signals.

In some embodiments, the UE can be configured to send a WUS for a node/cell A that is in sleep mode through a neighbor node/cell B, i.e., the node/cell B in this case “wakes up” node/cell A upon receiving a WUS from the UE for node/cell A.

In further embodiments, the UE can be configured to send a WUS directly to a node/cell A, in which case node/cell A is not in a fully sleep mode as it still needs to listen to certain UL signals, e.g., WUS signals.

In some embodiments, the UE can be configured with a mechanism to indicate the NW if it should stop the DTRX mechanism, i.e., be active as usual all the time, or based on a validity timer, or alternatively if the NW can start the DTRX mechanism. The former is useful, e.g., if the UE is a ultra-reliable low latency communication (URLLC) UE and needs low latency, and the latter is good when the UE has low traffic and thereby both the NW and UE can gain longer sleeping time.

The UE can be configured with a mechanism to provide its assistance information regarding e.g., the preferred DTRX configuration.

A UE may be configured with NW sleep occasions but only consider that the NW will sleep on those occasions upon receiving a further NW indication. Such further NW indication may be sent via DCI, MAC CE, dedicated RRC and/or SIB. The indication may be valid for a single sleep occasion, multiple sleep occasions where the number is indicated via the signaling, or for a time interval indicated in the signaling.

The configuration may contain different options (e.g., periodic sleeping occasions with different periodicities, one-shot, or semi-persistent sleeping occasions as discussed in A) that can be stored by the UE and triggered by the NW via MAC CE or DCI.

Each configuration option can be associated with the validity period that tells for how long the configuration is valid once it was triggered by the NW. This can be done, for example, via timer that the UE will start once the NW triggers one of the configuration candidates.

If the NW does not send the reconfiguration before the timer reaches the validity period value associated with the triggered configuration candidate, the UE can assume that the NW node will end the sleeping mode upon the timer expires.

During the duration of the timer, the UE can receive an indication from the NW that the current configuration will be applicable for longer time, in which case the UE updates the expiration value of the timer according to the NW indication.

During the duration of the timer, the UE can receive an indication from the NW that a different sleeping occasion configuration will be applicable for a certain period upon the timer expiration. Upon the expiration of the timer, the UE then updates the configuration and starts a new timer according to the NW indication.

During the duration of the timer, the UE can receive an indication from the NW that a different sleeping occasion configuration should be applied immediately upon the reception of the indication. In this case the UE does not wait for the timer to expire in order to update the configuration, but it updates the configuration and the associated timer values immediately upon the reception of the indication.

The neighbor cell DRTX information may be included. The information can be used by the UE, e.g., during radio link reestablishment, and e.g., during cell selection/reselection.

### NW Aspects

The NW can configure a group of the UEs with occasions where transmissions/receptions are not expected in order to achieve the synchronization among multiple UEs, and hence optimize the sleeping patterns of the UEs.

The NW can estimate the future transmission or reception occasions based on previous transmission or reception occasions of the UEs. Moreover, the NW can identify the groups of the UEs with similar transmission or reception occasions and optimize/adjust the sleeping patterns accordingly.

The NW can use the information from the UEs to further optimize/adjust the UE sleeping patterns.

In the case of handover, the candidate nodes that perform the sleep for energy savings communicate their sleeping occasions/patterns to the source node. This allows the source node to inform the UE via RRC not only about its own sleeping occasions but also about the sleeping occasions of the target node candidates. Based on this information, the UE can choose the right moment to trigger a random access (RA) towards a target node (i.e., it can initiate RA when a target node is awake), which can prevent a false radio link failure (RLF) that would occur if RA was initiated during a sleeping occasion of a target node.

The serving NG-RAN node may include its neighboring nodes sleeping occasions/patterns to the UE. If the UE is moving, the serving NG-RAN node could intelligently choose the relevant neighboring nodes as the UE potential handover target.

Some embodiments may be implemented in a split NG-RAN architecture. In that case, one or more of the following may apply to gNB DTRX determination and communication.

In some embodiments, the gNB DTRX is determined by a central unit (gNB-CU) and communicated to a distributed unit (gNB-DU). The gNB-CU has the overview knowledge of the load situation among the cells and the UEs/services being handled by the gNB. It is more suited to make a high-level decision, particularly when multiple cells have a synchronized DRTX policy. This may ensure, for example, that there would always be some cells available for services at any time. When making the decision about the DTRX, the gNB-CU may take into account the operator policy related to the NW energy saving.

In one embodiment, the gNB-CU indicates the DTRX decision to the gNB-DU, e.g., via F1AP interface setup or modification procedure.

In some embodiments, the gNB-DU may propose to the gNB-CU the DRTX settings for its cells. The gNB-CU then can use the overview knowledge as well as the gNB-DU proposal to make the final decision.

In another embodiment, the gNB-DU may propose the DRTX/cell to the gNB-CU via e.g., an F1AP procedure.

In some embodiments, the gNB DTRX may be determined by gNB-DU and communicate the gNB DTRX to the gNB-CU.

When DRTX is configured on a per cell basis, the gNB-DU should be the node entity to determine the DTRX. Upon making the decision about the DTRX, the gNB-DU can communicate it according to the following.

In one embodiment, the gNB-DU sends the information to the gNB-CU, via e.g., a F1AP setup or modification procedure, or via dedicated UE context procedure, so that the gNB-CU could later inform the UE via RRC signaling.

In another embodiment, the gNB-DU includes the information in RRC container which is sent to the UE.

In further embodiments, the gNB DTRX is proposed by the gNB-CU and determined by the gNB-DU. In one embodiment, the gNB-CU proposes the DTRX via an F1AP setup/modification procedure and the gNB-DU makes the final decision about the DTRX based on its own knowledge and the information received from the gNB-CU. Upon making the decision, the gNB-DU shall inform gNB-CU and/or UE about the DTRX according to the embodiments described above.

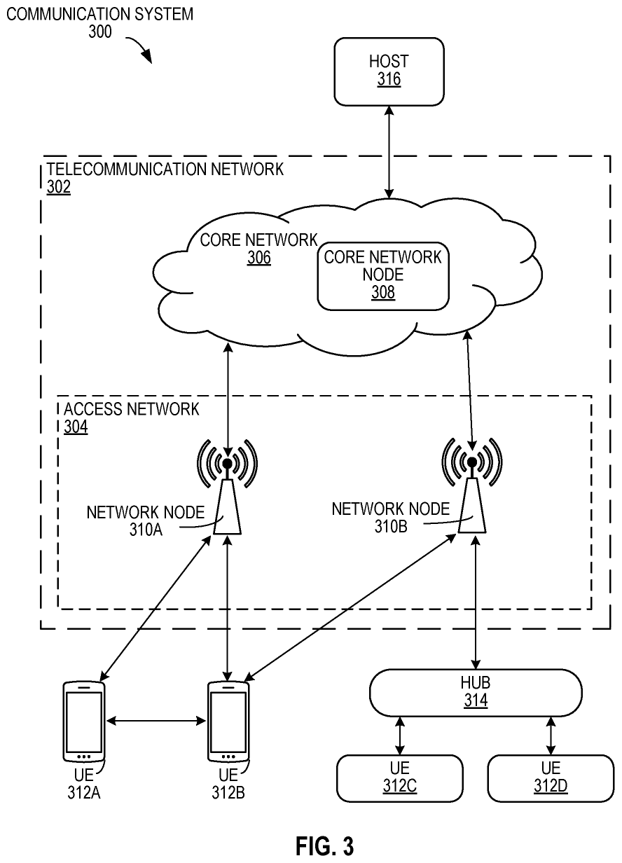

FIG. 3 shows an example of a communication system 300 in accordance with some embodiments.

In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3^{rd} Generation Partnership Project (3GPP) access node or non-3GPP access point. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub-that is, a hub whose primary function is to route communications to/from the UEs from/to the network node 310b. In other embodiments, the hub 314 may be a non-dedicated hub-that is, a device which is capable of operating to route communications between the UEs and network node 310b, but which is additionally capable of operating as a communication start and/or end point for certain data channels.

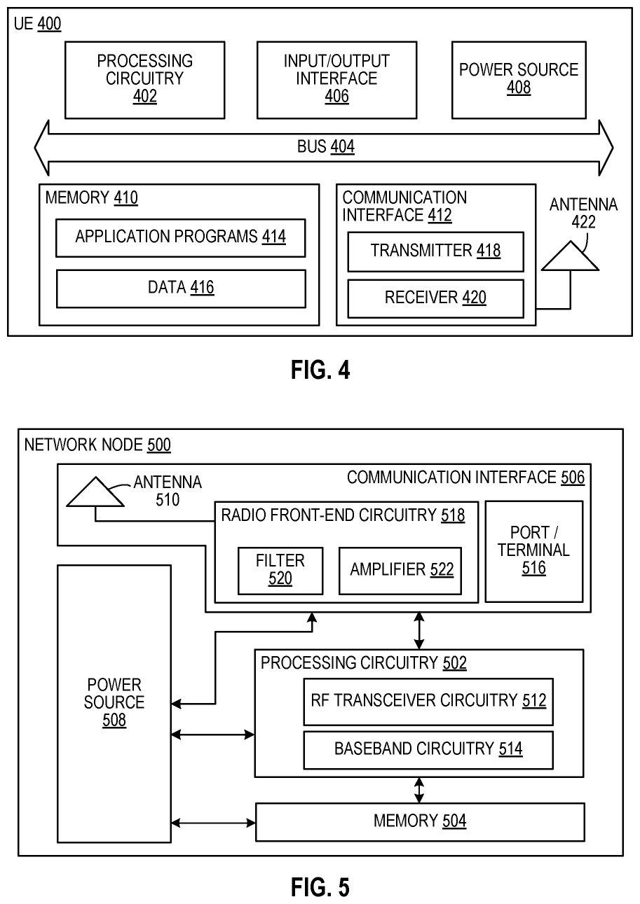

FIG. 4 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment.

Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

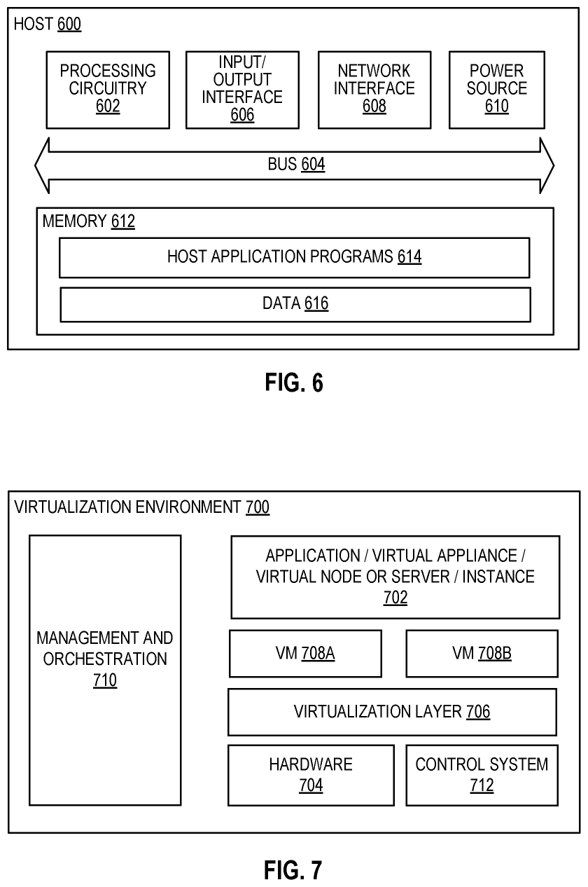

FIG. 6 is a block diagram of a host 600, which may be an embodiment of the host 316 of FIG. 3, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

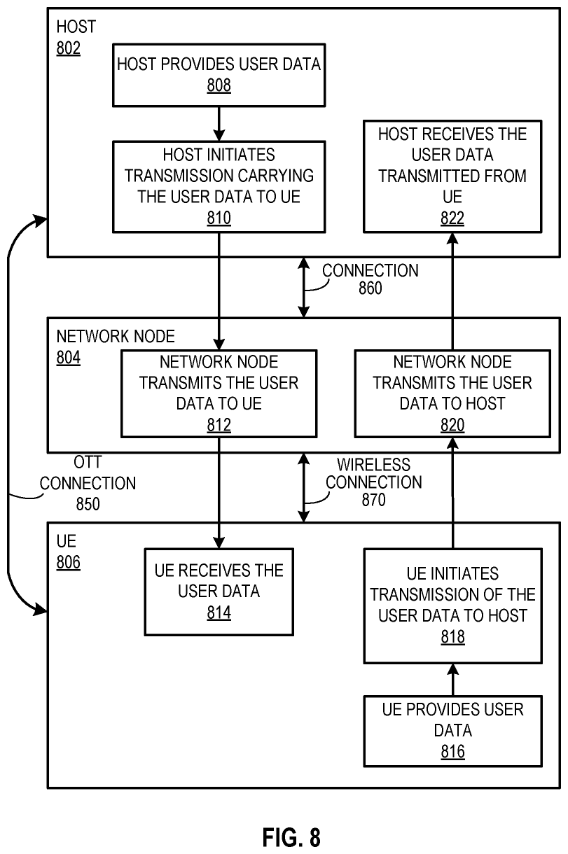

FIG. 8 shows a communication diagram of a host 802 communicating via a network node 804 with a UE 806 over a partially wireless connection in accordance with some embodiments. Example implementations, in accordance with various embodiments, of the UE (such as a UE 312a of FIG. 3 and/or UE 400 of FIG. 4), network node (such as network node 310a of FIG. 3 and/or network node 500 of FIG. 5), and host (such as host 316 of FIG. 3 and/or host 600 of FIG. 6) discussed in the preceding paragraphs will now be described with reference to FIG. 8.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 3) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve the power consumption of the UE, and thereby provide benefits such as extended battery lifetime.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, the method comprising:
receiving, from a wireless communication network, a configuration for sleeping occasions for a network node, wherein the configuration indicates an off-occasion during which transmission or reception activity by the network node is reduced or suspended; and
communicating with the network node in accordance with the configuration.

2. The method of claim 1, wherein communicating with the network node in accordance with the configuration comprises refraining from communicating with the network node while the network node is in an off-occasion according to the configuration.

3. The method of claim 1, wherein communicating with the network node in accordance with the configuration comprises communicating with the network node at a reduced frequency while the network node is in an off-occasion according to the configuration.

4. The method of claim 1, wherein the off-occasion applies to downlink transmissions from the network node to the UE.

5. The method of claim 1, wherein the off-occasion applies to uplink transmissions from the UE to the network node.

6. The method of claim 1, wherein the configuration comprises a periodic configuration that indicates a length of off-occasions and a periodicity of off-occasions for the network node.

7. The method of claim 6, wherein the configuration indicates a time when a first off-occasion of the configured off-occasions should occur.

8. The method of claim 1, wherein the configuration comprises an off-occasion timer during which transmission or reception activity by the network node is reduced or suspended and/or an on-occasion timer during which transmission or reception activity by the network node is normal.

9-13. (canceled)

14. The method of claim 1, further comprising:
receiving, from the network node, an updated configuration for sleeping occasions for the network node; and
communicating with the network node in accordance with the updated configuration.

15. The method of claim 14, wherein the updated configuration is provided via dedicated signaling.

16-26. (canceled)

27. The method of claim 1, wherein the configuration indicates a time when an on-occasion during which transmission or reception activity by the network node is not reduced or suspended will begin and/or a duration of the on-occasion.

28. A user equipment, comprising:
a processing circuitry;
a communication interface coupled to the processing circuitry; and
a memory coupled to the processing circuitry, wherein the memory comprises computer readable program instructions that, when executed by the processing circuitry, cause the user equipment to perform operations comprising:
receiving, from a wireless communication network, a configuration for sleeping occasions for a network node, wherein the configuration indicates an off-occasion during which transmission or reception activity by the network node is reduced or suspended; and
communicating with the network node in accordance with the configuration.

29. The user equipment of claim 28, wherein the program instructions further cause the user equipment to perform operations according to a method performed by a user equipment, UE, the method comprising:
receiving, from a wireless communication network, a configuration for sleeping occasions for a network node, wherein the configuration indicates an off-occasion during which transmission or reception activity by the network node is reduced or suspended; and
communicating with the network node in accordance with the configuration,
wherein communicating with the network node in accordance with the configuration comprises refraining from communicating with the network node while the network node is in an off-occasion according to the configuration.

30. (canceled)

31. A method performed by a network node, the method comprising:
transmitting, to a user equipment, UE, a configuration for sleeping occasions for the network node, wherein the configuration indicates an off-occasion during which transmission or reception activity by the network node is reduced or suspended; and
communicating with the UE in accordance with the configuration.

32. The method of claim 31, wherein the configuration is based on transmission or reception activity of UEs served by the network node.

33. The method of claim 31, wherein the configuration is based on a preferred configuration indicated by a UE served by the network node.

34. The method of claim 31, wherein the network node comprises a first network node, the method further comprising transmitting, to the UE, a configuration for sleeping occasions for a second network node, wherein the configuration indicates an off-occasion during which transmission or reception activity by the second network node is reduced or suspended.

35. The method of claim 31, wherein the network node comprises a central unit, CU, and a distributed unit, DU, the method further comprising:
determining the configuration at the CU; and
communicating the configuration from the CU to the DU.

36. The method of claim 31, wherein the network node comprises a central unit, CU, and a distributed unit, DU, the method further comprising:
determining the configuration at the DU; and
communicating the configuration from the DU to the CU.

37. The method of claim 31, wherein the network node comprises a central unit, CU, and a distributed unit, DU, the method further comprising:
determining a proposed configuration for discontinuous transmission or reception, DTRX, at the DU; and
communicating the proposed configuration for DTRX from the DU to the CU;
wherein the CU generates the configuration based on the proposed DTRX configuration.

38. The method of claim 31, further comprising:
obtaining user data; and
forwarding the user data to a host or a user equipment.

39. The method of claim 31, further comprising:
determining the configuration for sleeping occasions for the network node.

40. The method of claim 31, wherein the off-occasion applies to downlink transmissions from the network node to the UE.

41. The method of claim 31, wherein the off-occasion applies to uplink transmissions from the UE to the network node.

42-58. (canceled)

59. A network node, comprising:
a processing circuitry;
a communication interface coupled to the processing circuitry; and
a memory coupled to the processing circuitry, wherein the memory comprises computer readable program instructions that, when executed by the processing circuitry, cause the network node to perform operations comprising:
transmitting, to a user equipment, UE, a configuration for sleeping occasions for the network node, wherein the configuration indicates an off-occasion during which transmission or reception activity by the network node is reduced or suspended; and
communicating with the UE in accordance with the configuration.

60. The network node of claim 59, wherein the program instructions further cause the network node to perform operations according to a method performed by a network node, the method comprising:
transmitting, to a user equipment, UE, a configuration for sleeping occasions for the network node, wherein the configuration indicates an off-occasion during which transmission or reception activity by the network node is reduced or suspended; and
communicating with the UE in accordance with the configuration,
wherein the configuration is based on transmission or reception activity of UEs served by the network node.

61. (canceled)
